(19) United States
(12) Patent Application Publication
(10) Pub. No.: US 2008/0135326 A1
(43) Pub. Date: Jun. 12, 2008

(54) Talking Sticker

(76) Inventor: Sholeen L. Lou-Hsiao, Teaneck, NJ (US)

Correspondence Address: LIN & ASSOCIATES INTELLECTUAL PROPERTY, INC., P.O. BOX 2339, SARATOGA, CA, 95070-0339, US

(21) Appl. No.: 11/864,967

(22) Filed: Sep. 29, 2007

(30) Foreign Application Priority Data
Dec. 12, 2006 (TW) 095221895

(51) Int. Cl. G10K 15/00

(52) U.S. Cl. 181/141

(57) ABSTRACT

A talking sticker includes a lower base material having an attachment layer attached to a bottom surface thereof; an acoustic element mounted on an upper surface of the lower base material; an actuation element electrically connected with the acoustic element to actuate it to make a sound; and an upper base material having a pattern printed on a surface thereof and assembled with the lower base material. After assembled, the acoustic element and the actuation element are enclosed between the upper base material and the lower base material. The actuation element may be a contact switch or a sensor. When the actuation element is actuated, the acoustic element can make a pre-defined sound. Additionally, the talking sticker further includes a signal emitter defined therein and a separate acoustic fitting. Upon receiving a signal from the emitter, an acoustic element of the separate acoustic fitting can make a pre-defined sound.

### BACKGROUND OF THE INVENTION

1. Field of the Invention

The present invention relates to a talking sticker capable of being adhered on a planar surface of an object such as a wall, a tile, a desk, or a toy, which includes an acoustic element and a pattern printed on a surface of the talking sticker. Upon activation, an acoustic element, which can be embedded either in the sticker or in a separate acoustic fitting for use in connection with the sticker, can make a pre-defined sound. The present invention can provide many new uses with respect to conventional stickers and attract more users.

2. The Prior Arts

Currently, a conventional sticker is a thin material with an adhesive layer, and a surface of the thin material is printed with a pattern. But it can not make a sound. In order to add value to the sticker, it is thus desired to provide an improved sticker that has an additional functionality of being able to make a sound. That can be revolutionary to education and many other fields.

### SUMMARY OF THE INVENTION

The talking sticker has numerous new uses. One possible usage of the talking stickers, which can make a pre-defined sound, is to teach a target language through an immersion environment. Another usage of the talking stickers is to help vision-impaired people to identify objects. Furthermore, since children are generally attracted by stickers, the talking stickers can also be helpful to children's cognitive development and improve their language-learning effectiveness.

In accordance with the present invention, the talking sticker includes two embodiments: one is that an acoustic element is embedded in the sticker and another is that an acoustic element embedded in a separate acoustic fitting for use in connection with the sticker. In accordance with a first embodiment of the present invention, the talking sticker comprises a lower base material, an upper base material, an acoustic element, and an actuation element. The lower base material, which may be made from plastic material and configured to any shape, has an attachment layer attached to a bottom surface thereof. The attachment layer may be an adhesive coating or a magnet. The acoustic element, which includes a voice IC chip, a memory chip, a speaker, and a battery, is mounted on an upper surface of the lower base material. The actuation element is electrically, wired or wireless, connected with the acoustic element to actuate the acoustic element to make a pre-defined sound. The upper base material, which may or may not have the same material and shape with the lower base material, has a pattern printed on a surface thereof and assembled with the lower base material, wherein after assembled, the acoustic element and the actuation element are enclosed between the upper base material and the lower base material.

The actuation element may be a contact switch. When pressing the pattern on the surface of the upper base material to actuate the contact switch disposed on an upper surface of the acoustic element, the acoustic element can make a pre-defined sound.

The actuation element may also be a temperature sensor or a movement or capacitance sensor. When a person comes close to the talking sticker, the sensor can detect the person's body temperature or movement or capacitance and then transmit a signal to the acoustic element; thereby the acoustic element can make a pre-defined sound.

In accordance with the second embodiment of the present invention, the talking sticker comprises a signal emitter such as a Radio Frequency Identification tags (RFID tags) or a unique bar code, and a separate acoustic fitting including an acoustic element and a signal receiver. The acoustic element of the separate acoustic fitting, which includes a voice IC chip, a memory chip, a signal reader (with or without lenses), a speaker, a battery, and an on/off switch, can be wirelessly communicated with the talking sticker. When the signal receiver of the separate acoustic fitting receives a signal from the signal emitter of the talking sticker, the acoustic element will make a pre-defined sound.

Unlike the conventional sticker, the technical feature of the new sticker according to the present invention is to embed an acoustic element in a sticker or an separate acoustic fitting that is small and light weight, convenient to use and easy to carry. The talking sticker of the present invention can change the face of the conventional sticker and create new users.

### BRIEF DESCRIPTION OF THE DRAWINGS

The present invention will be apparent to those skilled in the art by reading the following detailed description of the preferred embodiments thereof, with reference to the attached drawings, in which:

FIG. 1 is a sectional view showing the structure of a talking sticker according to a first embodiment of the present invention;

FIG. 2 is an exploded perspective view of a talking sticker according to the first embodiment of the present invention;

FIG. 3 is a perspective view of a talking sticker according to the first embodiment of the present invention;

FIG. 4 is a schematic view showing the state that the talking sticker of the first embodiment of the present invention is pressed down;

FIG. 5 is an exploded perspective view of a talking sticker according to the first embodiment of the present invention;

FIG. 6 is a schematic view showing a duck-shaped talking sticker and a separate acoustic fitting according to a second embodiment of the present invention; and

FIG. 7 is a schematic view showing another talking sticker and another separate acoustic fitting according to the second embodiment of the present invention.

### DETAILED DESCRIPTION OF THE PREFERRED EMBODIMENT

The following descriptions are exemplary embodiments only, and are not intended to limit the scope, applicability or configuration of the present invention in any way. Rather, the following description provides a convenient illustration for implementing exemplary embodiments of the present invention. Various changes to the described embodiments may be made in the function and arrangement of the elements described without departing from the scope of the present invention as set forth in the appended claims.

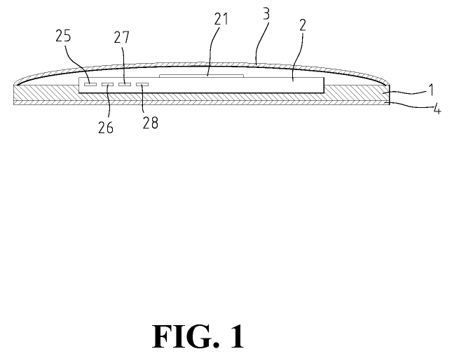

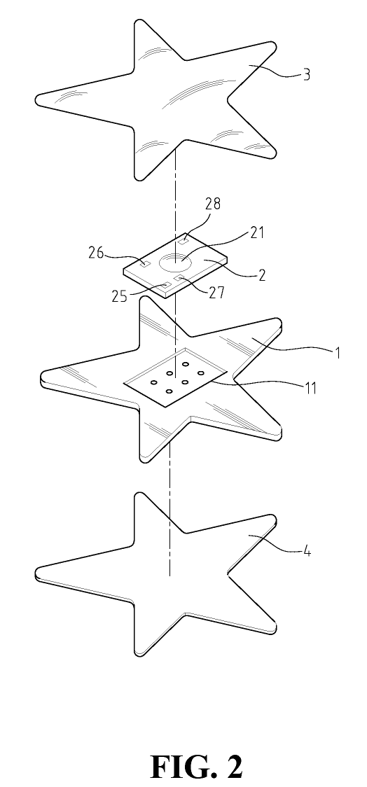

With reference to FIG. 1 and FIG. 2, a talking sticker in accordance with a first embodiment of the present invention comprises a lower base material 1, an acoustic element 2 and an upper base material 3. The acoustic element 2 includes a voice IC chip 25, a memory chip 26, a speaker 27 and a battery 28.

The lower base material 1 may be integrally formed to a thin rigid or soft plastic plate, which may be shaped as an animal, a doll, or any shape. The lower base material 1 has a first recess 11 defined on a top surface thereof and an attachment layer 4 provided on a bottom surface thereof. The attachment layer 4 may be an adhesive coating or a magnet.

The acoustic element 2 according to the first embodiment of the present invention has a smaller area than the lower base material 1. The acoustic element 2, which is received in the first recess 11, includes a contact switch 21 exposed in a top surface of the acoustic element 2. The acoustic element 2, which may include the voice IC chip, the memory chip, the speaker and the battery, can make a pre-defined sound like “star”, a telephone ringing, or a simple conversational sentence such as “I see a star”, etc.

The upper base material 3 may be directly integrally-formed, using injection molding process, on a surface of the lower base material 1, which is first assembled with the acoustic element 2. Accordingly, the upper base material 3 has a high flexible and recovery property. Or, the upper base material 3 may be pre-shaped with a convex surface and then is assembled with the lower base material 1, wherein the acoustic element 2 is enclosed between the upper base material 3 and the lower base material 1, and the acoustic element 2 keeps a small distance away from the upper base material 3. The upper base material 3 may have the same profile as the lower base material 1, and may be printed with a pattern like an object or an animal etc. on a surface of the upper base material 3. In accordance with the present invention, the acoustic element 2 may make a pre-defined sound describing the pattern printed on the upper base material 3. For example, when the pattern is a telephone, or a train, etc., the acoustic element 2 can make a sound like the telephone ringing, or the “train” sound, respectively.

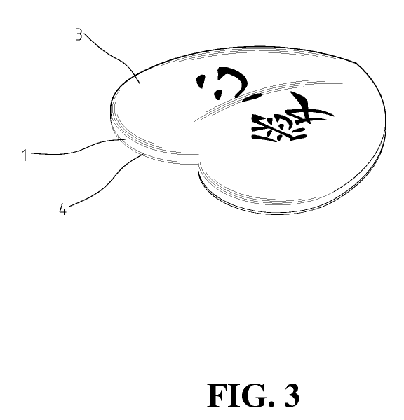

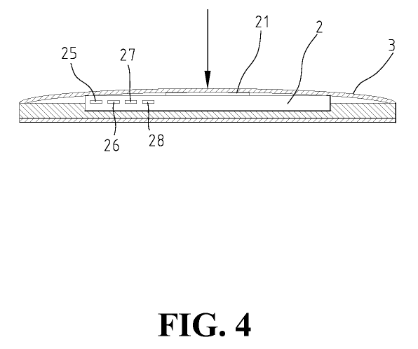

Please refer to FIG. 3 together with FIG. 1. FIG. 3 shows a perspective view of a talking sticker according to the first embodiment of the present invention. The lower base material 1 and the upper base material 3 are configured to a heart shape. Two Chinese characters “love heart” are printed on the surface of the upper base material 3, and the acoustic element 2 will pronounce “love heart” in Chinese. In using the talking sticker, a protection sheet of the attachment layer 4 on the lower base material 1 is first removed and an adhesive surface of the attachment layer 4 is exposed for adhering to a planar surface such as a wall or a desk. When pressing the surface of the upper base material 3, the contact switch 21 of the acoustic element 2 is actuated (see FIG. 4) and the acoustic element 2 can make a pronunciation of the two Chinese characters. When releasing the pressing force from the upper base material 3, the upper base material 3 recovers to the original state due to its elasticity.

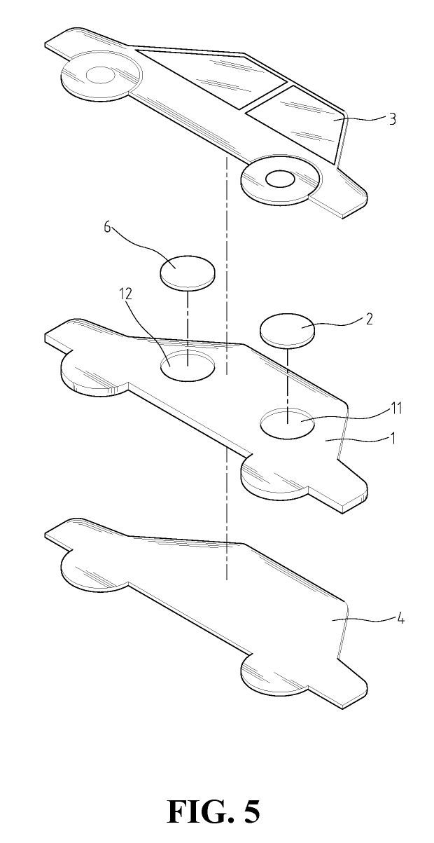

Please refer to FIG. 5, which is an exploded perspective view of a talking sticker according to the first embodiment of the present invention. A second recess 12 is defined on the surface of the lower base material 1, and a sensor 6 that replaces the contact switch 21 in FIG. 2 in function aspect is received in the second recess 12. The sensor 6 may be a temperature sensor or a movement or capacitance sensor. In accordance with the first embodiment of the present invention, the upper base material 3 and the lower base material 1 are configured to a car shape, and the surface of the upper base material 3 is printed with a car pattern, and the acoustic element 2 can make a car-horn sound. The acoustic element 2 is received in the first recess 11 of the lower base material 1, and is electrically, by wired or wireless way, connected with the sensor 6. After the lower base material 1 and the upper base material 3 are assembled together, the acoustic element 2 and the sensor 6 are enclosed there between. A bottom surface of the lower base material 1 has an attachment layer 4 attached thereto, which may be an adhesive coating or a magnet. In using the talking sticker, a protection sheet of the attachment layer 4 on the lower base material 1 is first removed and an adhesive surface of the attachment layer 4 is exposed for adhering to a planar surface such as a wall or a desk etc. When a person comes close to the talking sticker, the sensor 6 can detect the person's body temperature or movement or capacitance and transmit a signal to the acoustic element 2 to make a car-horn sound. If nobody comes close to the talking sticker, the sensor 6 detects no temperature or movement or capacitance signal; thereby the acoustic element 2 keeps silence.

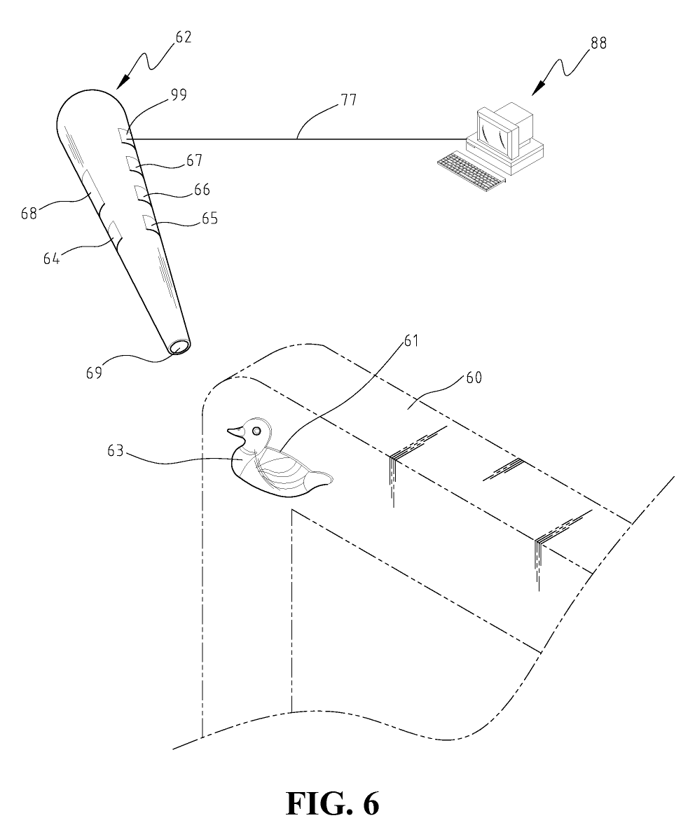

Please refer to FIG. 6, which shows a duck-shaped talking sticker 63 and a separate acoustic fitting 62 with a pen-shaped body according to a second embodiment of the present invention. The duck-shaped sticker 63 has a unique bar code printed on a top surface thereof. The attachment layer 61 may be an adhesive coating or a magnet that can be adhered to a metal oven door 60. The separate acoustic fitting 62 is a bar code reader having an acoustic element, which includes a voice IC chip 65, a memory chip 66, a speaker 67, a battery 68, and a bar code reader lens 69, and an on/off switch 64. When the acoustic fitting 62 touches the unique bar code printed on the top surface of the sticker 63, the acoustic fitting 62 reads out the bar code and makes a pre-defined sound of “duck” or “duck, hot, be careful.”

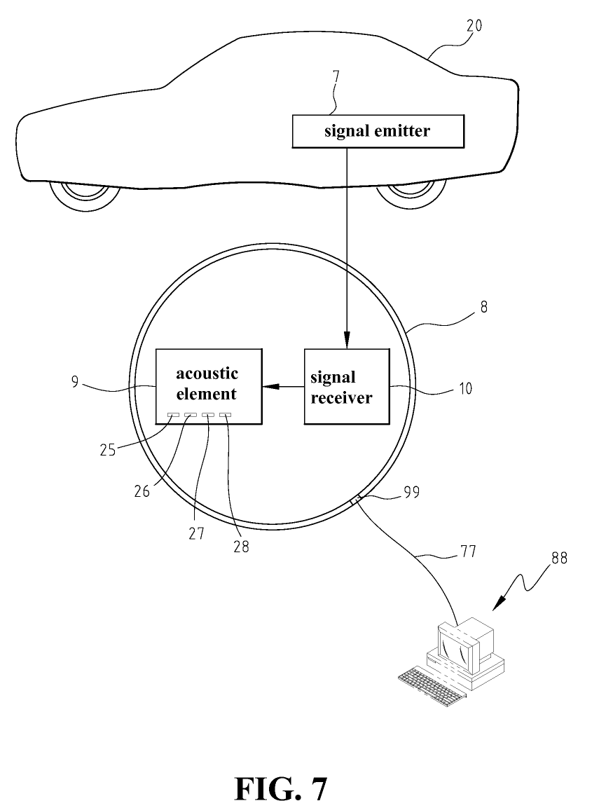

Please refer to FIG. 7, which shows a talking sticker in accordance with the second embodiment of the present invention. A sticker 20 with a car shape has a signal emitter 7, which may be a Radio Frequency Identification tag (RFID tag) that can be wirelessly connected to a separate acoustic fitting 8. The acoustic fitting 8 can be made in any form with any material, such as a teddy bear, a bracelet, or a necklace, which can be easily carried by users for communicating with the sticker 20. The acoustic fitting 8 includes an acoustic element 9 and a signal receiver 10 electrically connected with the acoustic element 9, in which the signal receiver 10 may be a RFID reader. When the signal receiver 10 of the acoustic fitting 8 receives a wireless signal from the signal emitter 7 of the talking sticker 20, the acoustic element 9 is actuated to make a sound pre-defined in the acoustic fitting 8. The acoustic element 9 includes a voice IC chip 25, a memory chip 26, a speaker 27 and a battery 28. The signal emitter and the signal receiver may be a RFID device.

Additionally, the acoustic fitting 8 in FIG. 7 and the acoustic fitting 62 in FIG. 6 may further include a connection socket 99 for connection with a computer 88 via a transmission line 77, so that the user can download other sounds or conversation to the acoustic fitting 8 in FIG. 7 and the acoustic fitting 62 in FIG. 6 from the computer 88, or update the original sounds recorded in the acoustic fitting 8 in FIG. 7 and the acoustic fitting 62 in FIG. 6.

Accordingly, no matter what type of the acoustic element (sensor type or touch switch type) can attract children's curiosity and attention, and promote effective learning.

The talking sticker according to the present invention is small and light weight, and also can be designed as any desired shape and size, which will not affect its basic function used as an sticker or a magnet. Compared with the conventional sticker, the talking sticker of the present invention not only is helpful to provide new learning tools, but also can aid different interest groups for their specific uses. Therefore, the talking sticker has more added value than the conventional sticker.

Although the present invention has been described with reference to the preferred embodiments thereof, it is apparent to those skilled in the art that a variety of modifications and changes may be made without departing from the scope of the resent invention which is intended to be defined by the appended claims.

What is claimed is:

1. A talking sticker, comprising:
a lower base material having an attachment layer attached to a bottom surface thereof,
an acoustic element mounted on an upper surface of the lower base material;
an actuation element electrically connected with the acoustic element to actuate the acoustic element to make a sound; and
an upper base material having a pattern printed on a surface thereof and assembled with the lower base material; wherein after assembled, the acoustic element and the actuation element are enclosed between the upper base material and the lower base material.

2. The talking sticker as claimed in claim 1, wherein the actuation element is a contact switch, which is disposed on an upper surface of the acoustic element.

3. The talking sticker as claimed in claim 1, wherein the actuation element is a sensor.

4. The talking sticker as claimed in claim 3, wherein the sensor is a temperature sensor.

5. The talking sticker as claimed in claim 3, wherein the sensor is a current sensor.

6. The talking sticker as claimed in claim 1, wherein the acoustic element includes a voice IC chip, a speaker, a battery for power, and a memory chip.

7. The talking sticker as claimed in claim 1, wherein the sound from the acoustic element is pre-defined.

8. The talking sticker as claimed in claim 1, wherein the attachment layer is an adhesive coating.

9. The talking sticker as claimed in claim 1, wherein the attachment layer is a magnet.

10. The talking sticker as claimed in claim 1, wherein the talking sticker further comprises a separate acoustic fitting, which is capable of being carried by a user and includes an acoustic element and a signal receiver; the talking sticker further includes a signal emitter, which is able to emit a signal to the signal receiver of the separate acoustic fitting so as to actuate the acoustic element of the separate acoustic fitting to make a pre-defined sound.

11. The talking sticker as claimed in claim 10, wherein the signal emitter and the signal receiver are a RFID device.

12. The talking sticker as claimed in claim 10, wherein the signal emitter is a unique bar code printed on a top surface of the talking sticker, and the signal receiver of the acoustic fitting is a bar code reader.

13. The talking sticker as claimed in claim 10, wherein the acoustic fitting further comprises a connection socket for connection with a computer via a transmission line.
